(19) United States
(12) Patent Application Publication
(10) Pub. No.: US 2025/0078298 A1
(43) Pub. Date: Mar. 6, 2025

(54) PROCESSING CONTROL METHOD, PROCESSING DEVICE, AND PROCESSING SYSTEM

(71) Applicant: Makeblock Co., Ltd., Shenzhen (CN)

(72) Inventors: Jianjun WANG, Shenzhen (CN); Yuanxiu ZHANG, Shenzhen, (CN)

(73) Assignee: Makeblock Co., Ltd., Shenzhen (CN)

(21) Appl. No.: 18/950,927

(22) Filed: Nov. 18, 2024

Related U.S. Application Data
(63) Continuation of application No. PCT/CN2023/137951, filed on Dec. 11, 2023.

(30) Foreign Application Priority Data
Dec. 30, 2022 (CN) 202211743699.1

(51) Int. Cl. G06T 7/521

(52) U.S. Cl. CPC G06T 7/521; G06T 2207/10028

(57) ABSTRACT

A processing control method, a processing device, a processing system are provided. The method includes the following. A light beam is emitted to a processing object to form a light beam coverage region on the processing object through lights in the light beam. Positional information of pixel points mapped by the measurement points is obtained from an image corresponding to the light beam coverage region. Coordinate information of each measurement point in the light beam coverage region is obtained according to a pre-configured calibration relationship and the positional information of the pixel points.

### CROSS-REFERENCE TO RELATED APPLICATIONS

This application is a continuation of International Application No. PCT/CN2023/137951, filed Dec. 11, 2023, which claims priority to Chinese Patent Application No. 2022117436991, filed Dec. 30, 2022, the entire disclosures of both of which are incorporated herein by reference.

### TECHNICAL FIELD

The disclosure relates to the field of laser processing technology, and in particular, to a processing control method, a processing device, and a processing system.

### BACKGROUND

With the development of processing device from industrial applications to end-user applications, the processing device is no longer limited to industrial applications. The processing device has become an intelligent hardware available for end-users, allowing people to perform laser processing on a processing object through the processing device.

### SUMMARY

According to an aspect of embodiments of the disclosure, a processing control method is provided, and the method includes the following. A light beam is emitted to a processing object to form a light beam coverage region on the processing object through lights in the light beam, where the light beam coverage region includes multiple measurement points. Positional information of pixel points mapped by the measurement points is obtained from an image corresponding to the light beam coverage region. Coordinate information of each measurement point in the light beam coverage region is obtained according to a pre-configured calibration relationship and the positional information of the pixel points, where the coordinate information is used for the processing on the processing object.

According to an aspect of embodiments of the disclosure, a processing device is provided. The processing device includes a housing, a rail apparatus, a laser head, and a communication component. The laser head slides through the rail apparatus. The communication component is configured to receive signal. The processing device is configured to execute the above processing control method.

According to an aspect of embodiments of the disclosure, a processing system is provided. The processing system includes a processing device and a processing control device. The processing device includes a housing, a rail apparatus, a laser head, and a communication component. The processing control device communicates with the processing device, and the processing control device is configured to control the processing device to execute the above processing control method.

### BRIEF DESCRIPTION OF THE DRAWINGS

The above and other purposes, features, and advantages of the disclosure will become more apparent by describing in detail exemplary embodiments of the disclosure with reference to the drawings.

FIG. 1 is an architecture diagram of a processing system applied in an embodiment of the disclosure.

FIG. 2 is a flow chart of a processing control method for a processing device provided in an embodiment of the disclosure.

FIG. 3 is a flow chart of emitting a light beam to a processing object to form a light beam coverage region on the processing object through lights in the light beam, provided in an embodiment of the disclosure.

FIG. 4 is a flow chart of obtaining positional information of the pixel points mapped by the measurement points from an image corresponding to the light beam coverage region, provided in an embodiment of the disclosure.

FIG. 5 is a schematic diagram of a calibration process provided in an embodiment of the disclosure.

FIG. 6 is a flow chart of a calibration process provided in an embodiment of the disclosure.

FIG. 7 is a flow chart of obtaining the coordinate information of each measurement point in the light beam coverage region according to a pre-configured calibration file and positional information of the pixel points, provided in an embodiment of the disclosure.

FIG. 8 is a flow chart of calculating reference coordinate information of measurement points according to a calibration relationship, provided in an embodiment of the disclosure.

FIG. 9 is a flow chart of operations after obtaining the coordinate information of each measurement point in the light beam coverage region according to a pre-configured calibration file and positional information of the pixel points, provided in an embodiment of the disclosure.

FIG. 10 is a schematic view of hardware of a processing device provided in an embodiment of the disclosure.

FIG. 11 is a schematic diagram of a processing control apparatus of a processing device provided in an embodiment of the disclosure.

FIG. 12 is a structural diagram of hardware of a processing device provided in an embodiment of the disclosure.

### DETAILED DESCRIPTION

Exemplary embodiments will now be described more fully with reference to the accompanying drawings. However, the exemplary embodiments may be implemented in various forms and should not be construed as limitations to the examples set forth herein; rather, these embodiments are provided so that the present disclosure will be more comprehensive and complete, and will fully convey the concept of exemplary embodiments to those of ordinary skill in the art. The accompanying drawings are merely schematic illustrations of the present disclosure and are not necessarily drawn to scale. The same reference numerals in the drawings indicate the same or similar structures, and thus their detailed description will be omitted.

In addition, the features, structures, or characteristics described may be combined in one or more embodiments in any suitable manner. In the following description, numerous specific details are provided to give full understandings of the embodiments of the present disclosure. However, those of ordinary skill in the art will realize that, technical solutions provided in the resent disclosure may be practiced by omitting one or more specific details, or by other methods, components, device, steps, etc. In other cases, well-known structures, methods, device, implements, materials, or operations will not be shown or described in detail to avoid obscuring aspects of the present disclosure.

Some of the block diagrams shown in the figures are functional entities and do not necessarily correspond to physically or logically separate entities. These functional entities may be implemented in software, or implemented in one or more hardware modules or integrated circuits, or implemented in different networks and/or processor devices and/or microcontroller devices.

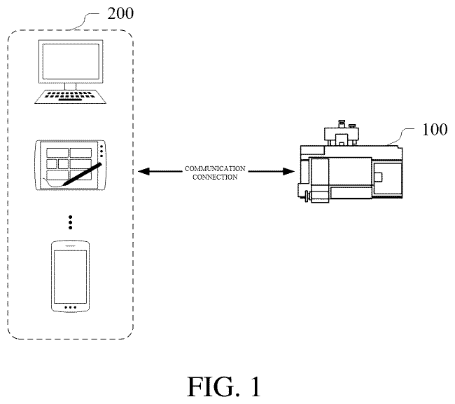

Reference is made to FIG. 1, which is an architecture diagram of a processing system applied in an embodiment of the disclosure. The processing system may include a processing device 100 and a processing control device 200. The processing control device 200 communicates with the processing device 100, and the processing control device 200 is configured to control the processing device 100 to execute a processing control method. Through an imaging process performed by the processing device 100, the laser carving or cutting can be observed, and the result of the laser carving or cutting can be displayed through visualization display.

In the disclosure, the term “processing” refers to changing the appearance, the performance, and/or the state of the material. Processing may include, for example, through-cutting, engraving, bleaching, curing, firing, etc. When specifically mentioned herein, engraving refers to a process in which a computer numerical control (CNC) machine changes the appearance of the material without completely penetrating the material. For example, for the processing device, processing may refer to removing some material from the surface or, for example, causing the material to change color by applying focused electromagnetic radiation that transmits electromagnetic energy as described below.

It is to be noted that, the processing performed by the processing device on the processing object includes the following. Firstly, the processing region of the processing object is measured, and the coordinate information of the processing region in the machine coordinate system constructed by the processing device is determined. A processing trajectory or a processing region model is then constructed according to the coordinate information of the processing region.

The disclosure provides a method for the processing device to measure processing regions of curved processing objects and planar processing objects. Based on this method, the coordinate information of the processing region is obtained. The processing device then constructs a processing trajectory and a processing region model based on the obtained coordinate information. A reference for the processing is made by simulating the processing trajectory on the processing region model or placing a processing pattern on the processing region model.

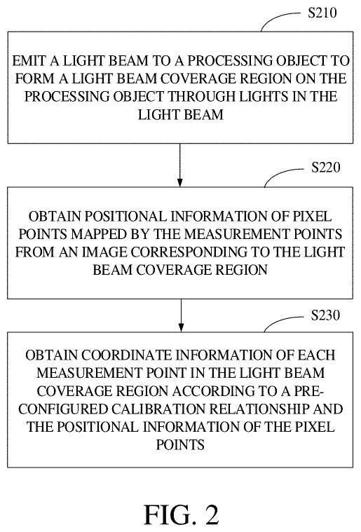

Reference is made to FIG. 2, which is a flow chart of a processing control method for a processing device provided in an embodiment of the disclosure. An embodiment of the disclosure provides the processing control method for the processing device, which includes the following.

At S210, a light beam is emitted to a processing object to form a light beam coverage region on the processing object through lights in the light beam.

At S220, positional information of pixel points mapped by measurement points is obtained from an image corresponding to the light beam coverage region.

At S230, coordinate information of each measurement point in the light beam coverage region is obtained according to a pre-configured calibration relationship and the positional information of the pixel points.

These three operations will be described in detail in the following.

At S210, the processing object is to be measured before the processing device performs the processing on the processing object carried by the processing device. Measurement points need to be formed on the surface of the processing object during the measurement. Therefore, the processing device controls the light source to emit a light beam to the processing object. Through lights in the light beam, the light beam coverage region including measurement points is formed on the surface of the processing object.

In an embodiment of the disclosure, the processing device provided in the disclosure is equipped with a light source and a camera. The relative position of the light beam coverage region to the camera remains unchanged. For example, the camera is always positioned directly above the light beam coverage region, so as to accurately capture each measurement point distributed in the light beam coverage region. For example, the relative position of the light source to the camera is fixed. The case may be that the light source and the camera are disposed on the same movement module of the processing device. Specifically, the light source and the camera may be both disposed on a movable movement module of the processing device. The movable movement module may be a movable laser head used for emitting laser to process a workpiece, a tool for mobile engraving, cutting, or indentation, or a movable nozzle of a 3D printer, etc. Alternatively, the light source may be fixed on the processing device, for example, on an inner wall of the processing device. By providing a galvanometer mirror and/or grids on the front end of the light source, the light beam coverage region is able to move with the camera, thereby maintaining the relative position of the light beam coverage region to the camera unchanged.

Moreover, as used in the disclosure, a “camera” includes, for example, a visible-light camera, a black-and-white camera, an infrared or ultraviolet sensitive camera, a separate luminance sensor such as a photodiode, a sensitive photon detector such as a photomultiplier tube or an avalanche photodiode, an detector for infrared radiation beyond the visible spectrum, such as a detector for microwaves, X-rays, or gamma-rays, an optical filtered detector, a spectrometer, and other detectors, which may include sources for providing electromagnetic radiation for illumination, so as to facilitate image acquisition, such as flashes, UV illumination, etc.

In an embodiment of the disclosure, grids are arranged in an optical path from the light source to a processing plane, so as to form the light beam coverage region on the processing object.

Specifically, the light source of the processing device emits the light beam to the processing object. The grids attached to the surface of the light source changes the optical path of the light beam, and thus the light beam coverage region corresponding to the grids is formed on the surface of the processing object through the lights in the light beam. The light beam coverage region includes multiple measurement points. The camera is used to capture the light beam coverage region on the processing object to obtain a corresponding image. The obtained corresponding image is a measurement image, which provides pixel points mapped by the measurement points and the positional information of the pixel points.

In an embodiment of the disclosure, the grids are attached to the surface of the light source in the form of a sticker, so that the optical path from the light source to the processing object is changed, and the light beam coverage region corresponding to the grids is formed on the processing object. Feature points included in the obtained measurement image may be used as measurement points. For example, in a grid-type measurement image, intersection between lines corresponding to the lights are used as measurement points.

It is to be noted that, the light source and the grids may be integrally formed and inseparable from each other. The light source and the grids may be detachably installed on the processing device as a whole, for example, the grids may be painted or etched on the front end of the light source. Alternatively, the light source and the grids may be of a separate structure. The light source and the grids are separable from each other, and are detachably installed on the processing device respectively. For example, a light source cover may be arranged on the front end of the light source, and the light source cover is connected to the light source through threads. The light source cover is hollow, and glass grids may be arranged in the hollow part of the light source cover.

In the processing device, the light beam emitted from the light source to the processing object may be infrared ray or other light beams that can be captured and identified by the camera, which is not limited herein.

The light source is controlled to emit the light beam to the processing object through the grids, so as to form the light beam coverage region on the processing object. Feature points in a corresponding image obtained by capturing the light beam coverage region are used as measurement points.

According to an embodiment of the disclosure, the grids may be of different types. The types of the grids may be distinguished according to the corresponding light beam coverage regions, such as dot-matrix grids or mesh-type grids. For example, the light source emits lights through the dot-matrix grids to form a dot-matrix light beam coverage region on the processing object, and the dots formed by the lights are the measurement points.

The light source emits lights through the mesh-type grids to form a mesh-type light beam coverage region on the processing object. In the mesh-type light beam coverage region, multiple parallel lines (set as parallel lines A) intersect with multiple parallel lines (set as parallel lines B, and the parallel lines A are not parallel to the parallel lines B) to form a mesh. Intersections of the parallel lines A and the parallel lines B are the measurement points. During usage of the processing device, grids with different shapes and corresponding to different numbers of measurement points may be flexibly chosen according to the need of measurement accuracy.

In an embodiment of the disclosure, the processing object includes planar processing objects and curved processing objects. The processing performed on a curved processing object will be taken as an example in this embodiment. For the processing device to perform a curved-surface processing, the curved processing object is placed on a material carrier. The surface of the curved processing object is a wavy curved surface.

For example, if a height difference between the highest point and the lowest point on a surface is greater than 1 mm, the surface is considered to be a curved surface with obvious wavy shape. Correspondingly, if the height difference between the highest point and the lowest point on a surface is less than 1 mm, the surface is considered to be a relatively flat surface, i.e., a planar surface.

The curved processing object is a curved workpiece to-be-processed. The curved processing object provides a curved surface to-be-processed for the processing device to perform curved-surface carving. For the curved surface to-be-processed, the processing device firstly controls the light source to emit the light beam through the grids, so as to form designated measurement points in the light beam coverage region on the curved surface to-be-processed, where the light beam coverage region corresponds to the grids.

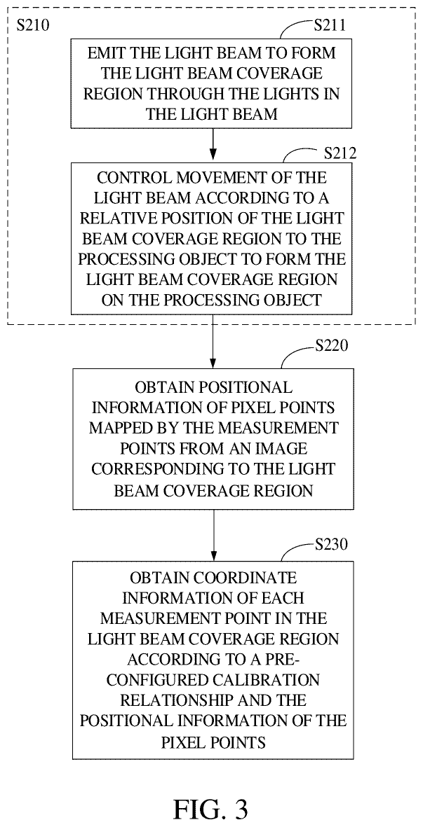

Reference is made to FIG. 3, which is a flow chart of emitting a light beam to a processing object to form a light beam coverage region on the processing object through lights in the light beam, provided in an embodiment of the disclosure. An embodiment of the disclosure provides that an operation at S210 of emitting the light beam to the processing object to form the light beam coverage region on the processing object through the lights in the light beam includes the following.

At S211, the light beam is emitted to form the light beam coverage region through the lights in the light beam.

At S212, movement of the light beam is controlled according to a relative position of the light beam coverage region to the processing object to form the light beam coverage region on the processing object.

These two operations will be described in detail in the following.

At S211, for the region measurement on the processing object, the processing device turns on the light source to emit the light beam to the processing object, so as to form the light beam coverage region on the surface of the processing object.

At S212, during the region measurement, the light source is turned on to emit the light beam while the position of the light beam on the processing object is adjusted to form the light beam coverage region on a designated processing region of the processing object, so as to measure the designated processing region.

The processing region refers to a portion of the processing object that can be processed. Therefore, the processing region is to be measured. In an embodiment of the disclosure, when the measurement begins, the light source is at an initial position and is not moved to the processing region. It is to be noted that, after the processing device completes the measurement on the processing region, the light source returns to the initial position. The processing device controls the movement of the light source to cover the light beam coverage region on the processing region of the processing object.

It is to be noted that, during the measurement on the processing object, there are two cases concerning the light beam coverage region covering the processing region of the processing object. One is that the light beam coverage region fully covers the processing region, and the other is that the light beam coverage region covers a part of the processing region.

Therefore, the processing device determines whether the light beam coverage region fully covers the processing region. If the light beam coverage region fully covers the processing region, the light source stops moving and the measurement operations are performed. If the light beam coverage region does not fully cover the processing region, the measurement operations are performed on the current light beam coverage region. The processing device then positions the processing region according to the input processing region, and controls the light source to move and measure the processing region until the entire processing region is measured.

Alternatively, whether the light beam coverage region fully covers the processing region may be determined according to the observation of the operator. If the light beam coverage region fully covers the processing region, the light source stops moving and the measurement operations are performed. If the light beam coverage region does not fully cover the processing region, the measurement operations are performed on the current light beam coverage region. The processing device then controls the light source in response to the operation of the operator to move and measure the processing region until the entire processing region is measured.

At S220, after the light source forms the light beam coverage region on the processing region, i.e., the measurement points are determined, the camera is triggered to take a picture of the light beam coverage region to obtain a corresponding image, where the corresponding image includes pixel points mapped by the measurement points. The positions of the pixel points are identified according to the corresponding image, and the positional information of the pixel points is obtained through calculation.

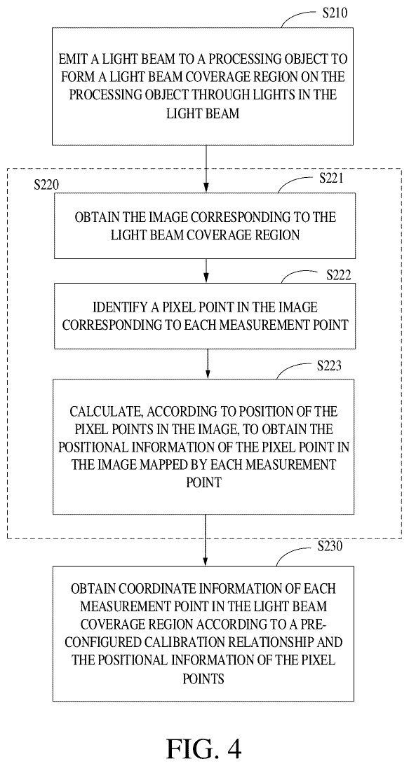

Reference is made to FIG. 4, which is a flow chart of obtaining positional information of the pixel points mapped by the measurement points from an image corresponding to the light beam coverage region, provided in an embodiment of the disclosure. An embodiment of the disclosure provides that an operation at S220 of obtaining positional information of the pixel points mapped by the measurement points from the image corresponding to the light beam coverage region includes the following.

At S221, the image corresponding to the light beam coverage region is obtained.

At S222, a pixel point in the image corresponding to each measurement point is identified.

At S223, the positional information of the pixel point in the image mapped by each measurement point is obtained by calculating according to positions of the pixel points in the image.

These three operations will be described in detail in the following.

At S221, when the light source stops moving or the light beam coverage region moves to a processing region to-be-processed on the processing object, an image corresponding to the light beam coverage region is obtained. In an embodiment of the disclosure, when the light source stops moving or the light beam coverage region moves to the processing region, the camera takes a picture of the light beam coverage region to obtain the corresponding image.

At S222, the pixel points corresponding to the measurement points are identified according to the corresponding image. For example, intersections of lines in the grid pattern in the image are identified as the pixel points, or dots in the dot matrix are identified as the pixel points. A corresponding relationship between the measurement points and the mapped pixel points in the corresponding image is established, and each pixel point corresponds to a measurement point.

At S223, a two-dimensional coordinate system is established with the corresponding image as the plane. The positional information of the pixel points is obtained according to the positions of the pixel points in the corresponding image. The positional information of the pixel points is the positions of the pixel points in the two-dimensional coordinate system established with the corresponding image as the plane.

At S230, during calculating the coordinate information of the measurement points according to the positional information of the pixel points identified in the image, a pre- configured calibration file corresponding to the measurement points needs to be obtained from the processing device. The obtaining of the calibration file will be described in detail in the following. The calibration file includes a calibration relationship between the positional information of the pixel points and the coordinate information of the measurement points. The coordinate information of each measurement point is obtained according to the positional information of the pixel points identified in the corresponding image, the calibration file, and the positional information of the camera.

In an embodiment of the disclosure, before the operation at S230, a calibration relationship between the positional information of each pixel point and a reference coordinate of the corresponding measurement point in the machine coordinate system of the processing device is pre-constructed. The calibration relationship indicates a relationship between the positional information of the pixel points and the reference coordinate information of the measurement points. The reference coordinate information is the coordinate information of the measurement point in the machine coordinate system with the camera as a reference point. It is to be noted that, the relative position of the camera to each measurement point in the light beam coverage region remains unchanged. Therefore, the relative position of the camera to each measurement point in the in the light beam coverage region remains unchanged, which means that the pre-constructed calibration relationship is available no matter how the camera or the light source moves, thereby greatly increasing the flexibility of large area measurement.

After the reference coordinate information of the measurement points is obtained, the reference coordinate information of the measurement points with the camera as the reference point needs to be updated to coordinate information in the machine coordinate system according to the coordinate information of the camera in the machine coordinate system, so as to obtain coordinate information of the measurement points in the machine coordinate system with the origin point as the reference point.

That is, the positional information of the pixel points represents the reference coordinate information of the measurement points in the machine coordinate system with the camera as the reference point. The reference coordinate information is the coordinate information of the measurement points in the machine coordinate system with the camera as the reference point.

For example, by projecting measurement points and taking picture, the pixel points and the corresponding image are obtained. The image is identified to obtain the positional information of the pixel points. The reference coordinate information of the measurement points in the machine coordinate system corresponding to the pixel points is obtained. The positional information of a pixel point and the reference coordinate information of a corresponding measurement point constitute a set of data, and linear fitting is performed on multiple sets of data to obtain the calibration relationship.

This is the calibration process. The obtained calibration relationship indicates the positional information of the pixel points and the reference coordinate values of the corresponding measurement points in each coordinate axis in the machine coordinate system, thereby obtaining the reference coordinate information of the measurement points. The reference coordinate information of the measurement points is used to describe the positions of the measurement points in three-dimensional space, representing the coordinate values of the measurement points in physical coordinate systems, such as the machine coordinate system constructed by the processing device with the camera as the reference point. For example, the reference coordinate information of the measurement points includes the coordinate values on X-axis, Y-axis, and Z-axis in the machine coordinate system constructed by the processing device with the camera as the reference point (in millimeters).

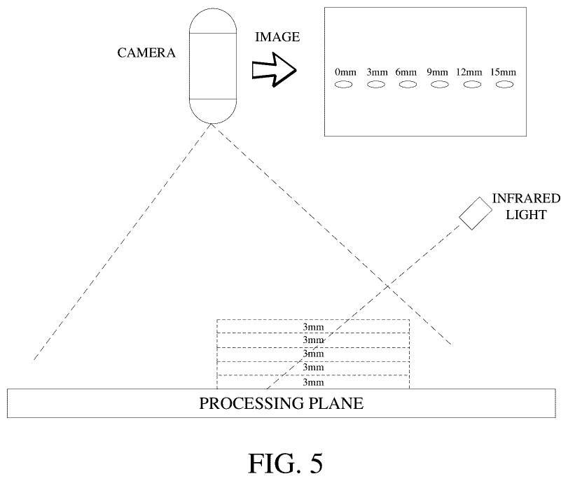

According to an embodiment of the disclosure, the calibration process may be performed once during the manufacturing of the processing device. Reference is made to FIG. 5, which is a schematic diagram of a calibration process provided in an embodiment of the disclosure. In an embodiment of the disclosure, the measurement points are projected on the processing object by the light source through the grids. The measurement points are formed on different positions of processing objects with different heights, corresponding to different reference coordinate information in the machine coordinate system.

For the image obtained during the calibration process, the positional information of the pixel points corresponding to the measurement points may be obtained through image identification. After the calibration process, the reference coordinate information of the measurement points in the machine coordinate system corresponding to the pixel points is obtained.

Thus, as illustrated in FIG. 5, the calibration is performed at a set height, and the positional information of the pixel points at the set height is mapped to the reference coordinate information of the measurement points in the machine coordinate system corresponding to the pixel points. For example, the set height starts at 0 mm and is increased by 3 mm for each calibration. For each height increment, the light source projects measurement points through the grids on the processing object, and images are captured. In this way, the positional information of the pixel points at each height and the reference coordinate information of the corresponding measurement points are obtained.

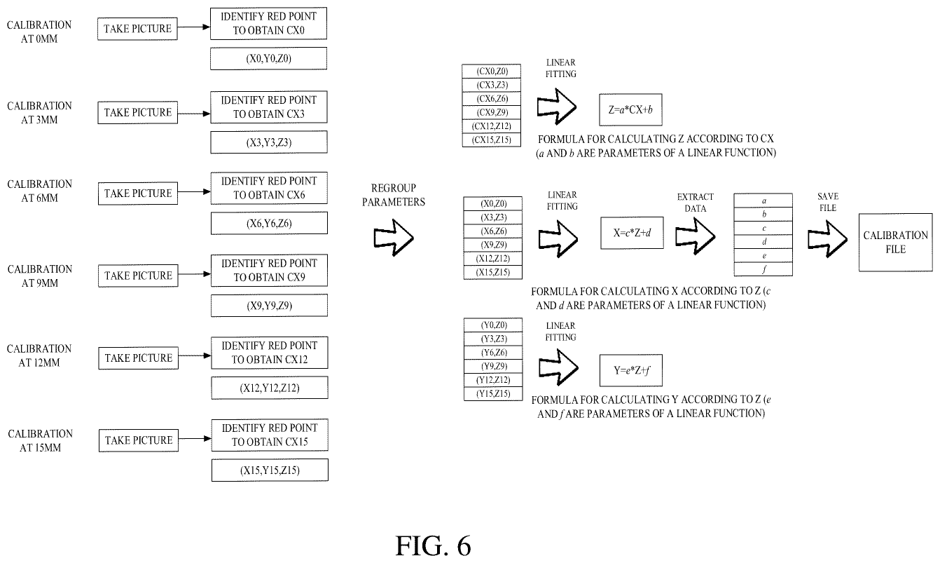

By analogy, the positional information of the pixel points and the reference coordinate information of the corresponding measurement points at each height are obtained. As previously described, for performing linear fitting on the positional information of the pixel points and the reference coordinate information of the corresponding measurement points, the reference coordinate information of the measurement points includes physical coordinates in the machine coordinate system, and the positional information of the pixel points and the reference coordinate information of the corresponding measurement points obtained from the calibration process at each height are regrouped into three sets of parameters. FIG. 6 is a flow chart of a calibration process provided in an embodiment of the disclosure. As illustrated in FIG. 6, for example, from 0 mm to 15 mm, with 0 mm as the starting height and 3 mm as the increment height, the calibration is performed at each height, such as 0 mm, 3 mm, 6 mm, 9 mm, 12 mm, and 15 mm.

For the calibration performed at each height, a set of parameters is obtained from each image, i.e., the positional information CX of the pixel points and the reference coordinate information (X, Y, Z) of the corresponding measurement points. This set of parameters will be regrouped.

For example, for the calibration performed at a certain height, the positional information CX of the pixel point and the reference coordinate information (X, Y, Z) of the corresponding measurement point constitute a set of parameters. The set of parameters is regrouped in pairs according to the positional information of the pixel point and reference coordinate value of the corresponding measurement point to obtain three sets of parameters, namely (CX, Z), (X, Z), and (Y, Z).

For the calibration performed at each height, three sets of parameters are obtained through regrouping. The same sets of parameters corresponding to different heights are collected together, for example, all the sets of parameter (CX, Z) are collected together. Linear fitting is performed, for example, on (CX0, Z0), (CX3, Z3), (CX6, Z6), (CX9, Z9), (CX12, Z12), and (CX15, Z15).

Through the regrouping and linear fitting, the mapping from positional parameters to the reference coordinate values is obtained. Specifically, the mapping includes the mapping from the positional parameters to the Z-axis reference coordinate values, the mapping from the X-axis reference coordinate values to the Z-axis reference coordinate values, and the mapping from the Y-axis reference coordinate values to the Z-axis reference coordinate values. Therefore, the calibration relationship between the positional information of the pixel points and the reference coordinate information of the corresponding measurement points is obtained and stored in the processing device in the form of calibration file.

For example, the mapping from the positional information of the pixel points to the reference coordinate information of the corresponding measurement points indicates a relationship between the positional information of the pixel points, the reference coordinate information of the corresponding measurement points, and the reference coordinate values. The relationship may be characterized by a linear function and its coefficients. Therefore, the coefficients used by the linear function are obtained through linear fitting, where the linear function corresponds to the positional information of the pixel points, the reference coordinate information of the corresponding measurement points, and the coordinate values. The coefficients are used to determine the corresponding linear function, and thus the reference coordinate information of the measurement points corresponding to the positional information of the pixel points is obtained.

For example, as illustrated in FIG. 6, the linear function obtained through the linear fitting between the positional information CX of the pixel points and the reference coordinate values of the measurement points, i.e., the Z-axis reference coordinate values, is Z=a*CX+b; the linear function obtained through the linear fitting between the X-axis reference coordinate values and the Z-axis reference coordinate values is X=c*Z+d; and the linear function obtained through the linear fitting between the Y-axis reference coordinate values and the Z-axis reference coordinate values is Y=e*Z+f.

a, b, c, d, e, and fare coefficients read from the calibration file obtained in the calibration.

Therefore, the coefficients obtained through the linear fitting are obtained to form the calibration file. Correspondingly, in the measurement of the measurement points, the calibration file is invoked to obtain the calibration relationship between the positional information of the pixel points and the reference coordinate information of the corresponding measurement points.

The reference coordinate value constitutes the calibration relationship between the positional information of the pixel points and the reference coordinate information of the corresponding measurement points for the positional parameters of the corresponding measurement points, which is achieved mainly through the following manner. The calibration relationship between the positional information of the pixel points and the reference coordinate information of the measurement points is obtained in advance. This calibration relationship indicates the reference coordinate value of the measurement points corresponding to the positional information of the pixel points, where the measurement points are in the machine coordinate system with the camera as the reference point. The reference coordinate value constitutes the reference coordinate information of the corresponding measurement points. Calibration is performed at each measurement point, so as to form a corresponding calibration file.

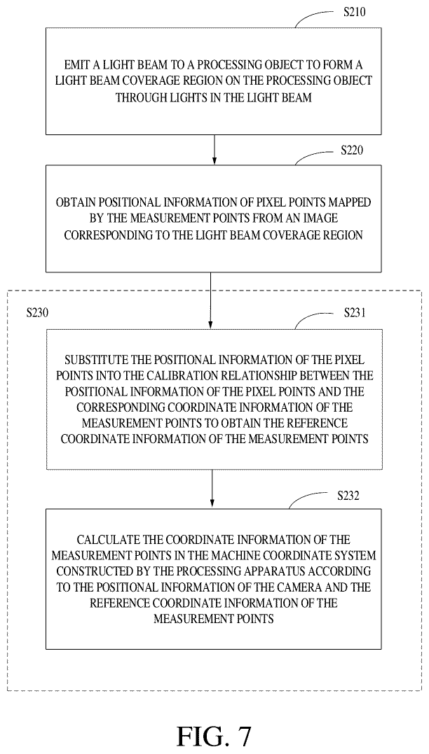

Reference is made to FIG. 7, which is a flow chart of obtaining the coordinate information of each measurement point in the light beam coverage region according to a pre-configured calibration file and positional information of the pixel points, provided in an embodiment of the disclosure. An embodiment of the disclosure provides that an operation at S230 of obtaining the coordinate information of each measurement point in the light beam coverage region according to the pre-configured calibration file and the positional information of the pixel points includes the following.

At S231, the positional information of the pixel points is substituted into the calibration relationship between the positional information of the pixel points and the coordinate information of the corresponding measurement points to obtain the reference coordinate information of the measurement points.

At S232, the coordinate information of the measurement points in the machine coordinate system constructed by the processing device is calculated according to the positional information of the camera and the reference coordinate information of the measurement points.

These two operations will be described in detail in the following.

At S231, after obtaining the positional information of the pixel points through the corresponding image obtained in the operation at S220, the calibration file is read to obtain the required calibration relationship during the execution of the operation at S231.

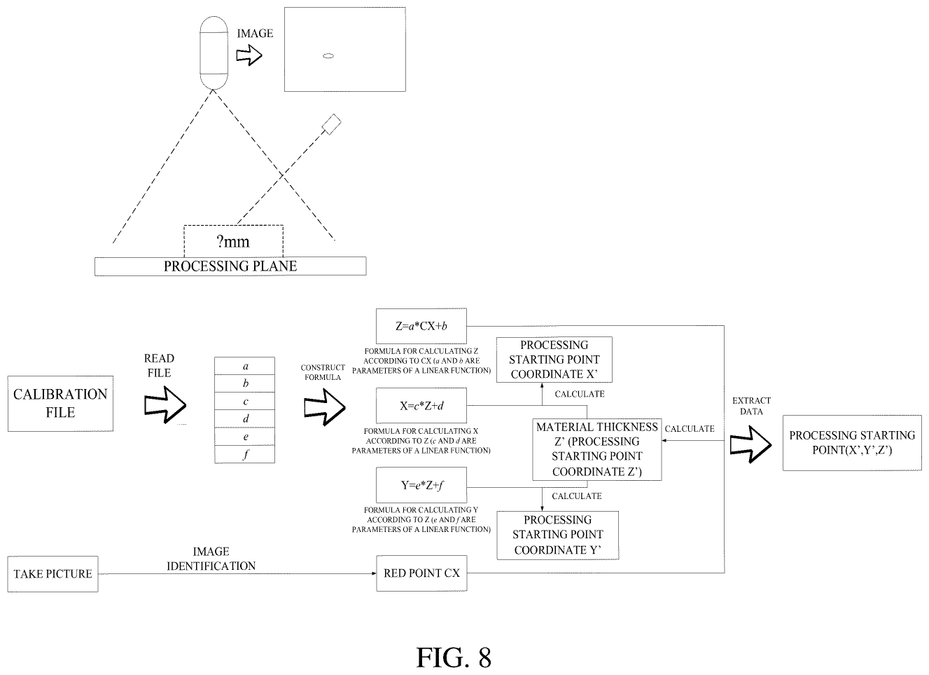

Specifically, FIG. 8 is a flowchart of calculating reference coordinate information of measurement points according to a calibration relationship, provided in an embodiment of the disclosure. As illustrated in FIG. 8, the reference coordinate information refers to the coordinate information of the measurement point in the machine coordinate system with the camera as the reference point. At S231, the coefficients are firstly read from the calibration file corresponding to the measurement point, and formulas are constructed using the read coefficients, that is, a linear function between positional information of the pixel points and a reference coordinate value Z: Z=a*CX+b, and the linear functions between reference coordinate values: X=c*Z+d, Y=e*Z+f.

Based on the obtained image, which shows the pixel points corresponding to the measurement points, the positional information CX′ of the pixel points is obtained through image identification, and then Z′, Y′, and X′ are sequentially calculated according to the constructed linear function. Z′, Y′, and X′ constitute the reference coordinate information of the measurement point corresponding to the pixel point.

This is the process of calculating the reference coordinate information of a measurement point in the light beam coverage region. Similarly, the reference coordinate information of each measurement point is obtained respectively. It is to be note that in an embodiment of the disclosure, the relative position of the light source to the camera is fixed.

At S232, according to the reference coordinate information of the measurement points obtained in the operation at S231 and the coordinate information of the camera in the machine coordinate system with an original point as a reference point, the coordinate information of the measurement points in the machine coordinate system with the original point as the reference point is calculated.

It is to be noted that, for the structured light, a specific wavelength of invisible laser is typically used as the light source, and the light with encoded information is emitted and projected on an object. The distortion of the returned encoded pattern is calculated through algorithms to obtain the positional information and depth information of the object. Unlike the structured light, in the disclosure, with the positional information of the pixel points corresponding to the processing objects with different heights and the pre-configured calibration relationship, the coordinate information of the measurement points is obtained, which greatly reduces the computation required for calculating the coordinate information of the measurement points and improves the measurement efficiency. On the other hand, devices related to structured light are relatively expensive. As previously described, the configuration provided in the disclosure is simple and cost-effective.

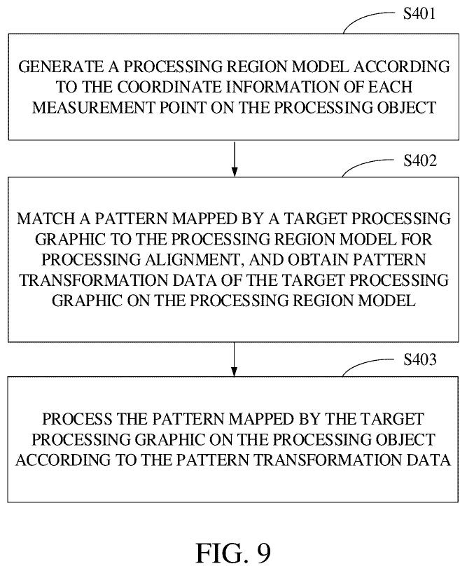

Reference is made to FIG. 9, which is a flow chart of operations after obtaining the coordinate information of each measurement point in the light beam coverage region according to a pre-configured calibration file and positional information of the pixel points, provided in an embodiment of the disclosure. An embodiment of the disclosure provides that an operation after obtaining the coordinate information of each measurement point in the light beam coverage region according to a pre-configured calibration file and positional information of the pixel points includes the following.

At S401, a processing region model is generated according to the coordinate information of each measurement point on the processing object.

At S402, a pattern mapped by a target processing graphic is matched to the processing region model for processing alignment, and pattern transformation data of the target processing graphic on the processing region model is obtained.

At S403, the pattern mapped by the target processing graphic is processed on the processing object according to the pattern transformation data.

These three operations will be described in detail in the following.

At S401, the coordinate information of each measurement point in the processing region is a numerical description of the processing region. Therefore, according to the position in the machine coordinate system constructed by the processing device indicated by the coordinate information of each measurement point, a three-dimensional processing region may be determined, so as to generate a processing region model.

In other words, the processing region model is a numerical description of the processing region provided by the processing object. For the processing performed by the processing device, the generated processing region model, especially for the processing region model with a curved surface, is used for processing alignment of the processing object to be processed, and also provides a preview function for the processing.

At S402, the target processing graphic is derived from a library of an upper computer, user input, screenshots of audio-visual files, etc. The target processing graphic is used for providing an engraving pattern for the processing to-be-executed, and the engraving pattern is a pattern mapped by the target processing graphic. The target processing graphic includes but is not limited to fonts, lines, patterns, etc.

In other words, in the disclosure, the laser processing is to engrave the pattern mapped by the target processing graphic on the processing region. The pattern mapped by the target processing graphic is matched to the processing region provided by the processing object, thereby allowing the pattern to be engraved on a specific location in the processing region.

It is to be understood that, for the pattern engraved in the processing region, the position and the arrangement at the position may be designated, and the size of the engraved pattern is matched to the designated position. Therefore, the pattern may be rotated, translated, and scaled according to the designated configuration. It is to be noted that the pattern is also matched to the curved surface to-be-processed, and the pattern may deform according to the undulation of the curved surface.

By aligning the pattern on the processing region model, the pattern mapped by the target processing graphic is transformed, and the pattern transformation data is obtained, which numerically characterizes and describes the pattern engraved in the processing region.

At S403, the processing region is matched to the processing object, and the processing parameters are obtained. The obtained processing parameters include power, the movement speed of laser head, etc. For the processing region engraving performed by the processing device, the power of the laser emitted by the laser head and the movement speed of the laser head are configured according to the obtained processing parameters. Exemplarily, the processing parameters may be transmitted from the upper computer to the processing device for use.

Under the control of the processing parameters and the pattern transformation data, the pattern mapped by the target processing graphic is processed on the processing object.

In some embodiments, the processing device includes a housing, a movable head, and a camera. The housing defines a processing space, and the camera is disposed in the housing. The camera may be located at a top portion, a side portion, or a junction of the top portion and the side portion of the processing space. When the processing object is processed by the processing device, at least part of the processing object is in the processing space of the processing device. The camera is configured to capture an image of the at least part of the processing object.

In some embodiments, the laser processing of the processing device includes the following. A processing movement scheme for the movable head is generated. A preview image of an expected target processing pattern to be produced on the processing object is generated. The processing device sends the laser to the processing object according to the processing movement scheme to process the processing object.

Specifically, through the display of the preview image, the user can easily perform visualized operations such as editing, aligning, scaling, and viewing the target processing pattern. After the user edits and aligns the target processing pattern and adjusts the processing parameters, the processing movement scheme for the movable head is generated. The processing movement scheme includes, but is not limited to speed of movement, path of movement, and duration of movement. The movable head transmits electromagnetic energy to the processing object according to the processing movement scheme to process the processing object. Processing the processing object includes operations such as carving, cutting, pressing, and material spraying printing, etc.

In an embodiment, a barrier that can be opened and closed is disposed in the housing. The operator can open the processing space by opening the barrier to place or remove the processing object, i.e., the workpiece. The barrier can be made of translucent material. In this way, the user can observe the laser processing on the processing object in the processing space through the barrier when the barrier is closed. The barrier can filter high-energy laser to weaken the laser transmission from the processing space to the external space of the processing device. In this way, laser spill may be reduced, thereby avoiding injuring the user.

In an embodiment, a laser device may be disposed in the movable head to generate and output laser. The type of the laser device may include but is not limited to a semiconductor laser device, a solid laser device, a fiber laser device, etc.

In an embodiment, a laser device may be disposed in the processing device, and the laser device may be a galvanometer laser device. The galvanometer laser device outputs laser and changes the direction of laser emission through the galvanometer to perform laser processing on the processing object.

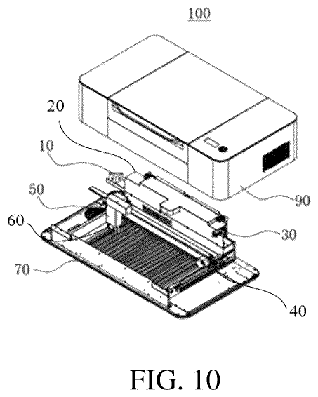

FIG. 10 is a schematic view of hardware of a processing device 100 provided in an embodiment of the disclosure. In an embodiment, as illustrated in FIG. 10, the processing device 100 includes a housing, a rail apparatus 40, a movable laser head 50, and a communication component 20. The communication component 20 is configured to receive signal. The processing device 100 may further include a light source 30, and a camera 60, which may include a close-up camera, and a distant camera. The housing includes an upper housing 90 and a bottom housing 70. The close-up camera is disposed on the laser head 50. The processing device 100 integrates the cameras, that is, the processing device 100 includes, but is not limited to, a distant camera for capturing panoramic processing images and the close-up camera. The close-up camera is movable and is able to capture images. The movable head may include the laser head 50.

In an embodiment, laser source may be generated by the laser head 50. In another embodiment, the laser source may be generated by other components, for example, a laser tube of a carbon dioxide laser tube, etc. The laser source enters a laser-emitting apparatus through a reflecting mirror 10, and then the laser source is emitted from the laser head 50 to process the workpiece.

In an embodiment, the reflecting mirror 10 is disposed between the laser head 50 and the laser tube. The laser generated by the laser tube is reflected by the reflecting mirror 10, and enters the laser head 50. After optical adjustment such as reflection and focusing, the laser is emitted from the movable head 50 to process the workpiece.

In an embodiment, the housing of the laser processing device 100 includes the upper housing 90 and the bottom housing 70 illustrated in FIG. 10. The upper housing 90 and the bottom housing 70 cooperatively enclose to define an internal space that can accommodate a processing object. The connection between the upper housing 90 and the bottom housing 70 can be detachable connection or fixed connection, or the upper housing 90 and the bottom housing 70 are integrally formed. In order to perform laser processing, the laser head 50, the light source 30 (for example, a light tube), and the close-up camera are disposed in the internal space. The laser head 50 and the close-up camera slide through the rail apparatus 40.

In an embodiment, the upper housing 90 is also provided with a rotatable cover plate, and the operator can open or close the cover plate to open the internal space for placing or removing the workpiece. The cover plate may be the barrier that can be opened and closed.

The blocking and/or filtering effect of the upper housing 90 and the bottom housing 70 can prevent the laser emitted from the laser head 50 from spilling during the operation, thereby avoiding injuring the operator.

Exemplarily, in an embodiment, the rail apparatus 40 may be disposed in the internal space. The laser head 50 is mounted on the rail apparatus 40. The rail apparatus 40 may include an X-axis rail, and a Y-axis rail. The X-axis rail and the Y-axis rail may be linear rails, or rails with a roller axel and a roller that are in slid fit, as long as the laser head 50 can be driven to move on the X-axis rail and the Y-axis rail to perform the processing. There may be a Z-axis rail disposed in the laser head 50, so that the laser head 50 can move to adjust focus in the Z-axis direction before and/or during the processing.

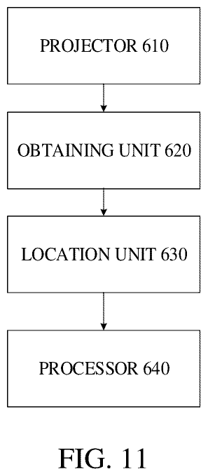

Reference is made to FIG. 11, which is a schematic diagram of a processing control apparatus of a processing device provided in an embodiment of the disclosure. An embodiment of the disclosure provides the processing control apparatus of the processing device, which includes a projector 610, an obtaining unit 620, a location unit 630, and a processor 640.

The projector 610 is configured to emit a light beam to a processing object to form a light beam coverage region on the processing object through lights in the light beam.

The obtaining unit 620 is configured to obtain positional information of pixel points mapped by the measurement points from an image corresponding to the light beam coverage region.

The location unit 630 is configured to obtain coordinate information of each measurement point in the light beam coverage region according to a pre-configured calibration relationship and the positional information of the pixel points.

The processor 640 is configured to execute the method described in any of the above embodiments.

Among the description of these operations, it is to be firstly stated that the processing device provided in embodiments of the disclosure can process curved processing objects. The processing device is designed for end-users, and can be used by the terminal. Processing devices used in industry can certainly process curved surfaces, but the apparatus and sensors installed on the processing devices for this purpose are very expensive. Considering cost and other factors, the processing devices used by the end-users are generally not equipped with expensive apparatus and sensors installed on the processing devices used in industry. The processing device provided in embodiments of the disclosure can perform low-cost region measurement while having the ability to process curved surfaces without relying on expensive apparatus and sensors, which is highly needed in the current laser processing field.

The processing device processing a curved surface is taken as an example to describe the method provided in the disclosure, where the method is applied to the processing device processing the processing object.

The curved processing object is a workpiece to-be-processed with a curved surface. The curved surface provides a curved processing region for the processing device.

The light source of the processing device projects lights on the curved processing object through the grids to form a grid pattern in the processing region of the curved processing object. The region covered by the grid pattern is the light beam coverage region. The light beam emitted from the light source may be infrared ray or other light beams that can be captured and identified by the camera. The intersections of the lines in the grids are the measurement points.

After the light source moves to a designated position, a picture of the light beam coverage region is taken to obtain the corresponding image. The corresponding image is identified to clarify the correspondence between the pixel points and the measurement points. With the center of the corresponding image as a reference point, the positional information of each pixel point is obtained. According to the positional information of each pixel point and the calibration file corresponding to each pixel point, the reference coordinate information of each measurement point is obtained. Finally, according to the reference coordinate information of the measurement points and the positional information of the camera, the coordinate information of each measurement point in the curved processing region is obtained. The position of the camera is obtained through the positioning function of the processing device.

According to the coordinate information of each measurement point in the processing region, the processing device performs linear fitting between points and surface fitting between lines. The curved processing region model is obtained. The curved processing region is used for processing alignment of the processing, and can also provide a preview function for the processing.

The pattern mapped by the target processing graphic is matched to the curved processing region, thereby allowing the pattern to be engraved on a specific location in the processing region. The pattern can be rotated, translated, and scaled according to the designated configuration. It is to be noted that the pattern is matched to the curved surface to-be-processed, and the pattern may deform according to the undulation of the curved surface.

By aligning the pattern on the processing region model, the pattern mapped by the target processing graphic is transformed, and the pattern transformation data is obtained, which numerically characterizes and describes the pattern engraved in the processing region. The processing region is matched to the processing object, and the processing parameters are obtained. Under the control of the processing parameters and the pattern transformation data, the pattern mapped by the target processing graphic is processed on the processing object.

It is to be noted that, when measuring the processing region, whether the light beam coverage region covers the curved processing region is to be determined. If the light beam coverage region covers the curved processing region, measurement is performed directly. If the light beam coverage region does not cover the curved processing region, measurement is performed first, then the light beam coverage region is translated until the entire curved processing region is measured.

The light beam is firstly emitted, and the emitted light beam indicates the measurement points on the curved surface to-be-processed. Irradiation points formed on the curved surface to-be-processed by the light beam are the currently indicated measurement points.

After forming the irradiation points on the curved surface to-be-processed by the emitted light beam, the camera is triggered to take a picture. An image of the curved processing object is obtained. The position parameter of the measurement point is calculated based on the position of the irradiation point identified in the image, thereby completing the measurement of one measurement point.

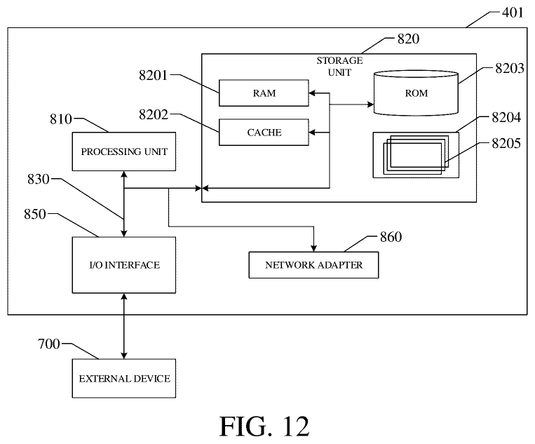

The processing control method applicable to a processing device provided in embodiments of the disclosure can be executed by the processing device 100 in FIG. 12. The processing device 100 provided in embodiments of the disclosure will be described in the following with reference to FIG. 12. The processing device 100 illustrated in FIG. 12 is merely an example and should not limit the functionality and scope of use of the embodiments of the disclosure.

As illustrated in FIG. 12, the processing device 100 is illustrated in the form of a general computer device 401. Components of the processing device 100 may include, but are not limited to: at least one processing unit 810, at least one storage unit 820, and a bus 830 connecting different system components (including the storage unit 820 and the processing unit 810).

The storage unit stores program code. The program code, when executed by the processing unit 810, may cause the processing unit 810 to perform the operations according to the example embodiments of the disclosure described in the example methods in this specification. For example, the processing unit 810 may perform each operation illustrated in FIG. 2.

The storage unit 820 may include a readable medium in the form of a volatile storage unit, for example, a random access memory (RAM) 8201 and/or a cache storage unit 8202, and may further include a read-only memory (ROM) 8203.

The storage unit 820 may further include a program/utility tool 8204 having a group of (at least one) program modules 8205. Such a program module 8205 includes, but is not limited to, an operating system, one or more application programs, other program modules, and program data. Each or a combination of these examples may include implementation of a network environment.

The bus 830 may represent one or more of several types of bus structures, including a storage unit bus or storage unit controller, a peripheral bus, an accelerated graphics port, a processing unit, or a local bus using any one of a plurality of bus structures.

The processing device 100 may alternatively communicate with one or more external devices 700 (such as a keyboard, a pointing device, and a Bluetooth device), may alternatively communicate with multiple devices that enable a user to interact with the processing device 100, and/or communicate with any device (such as router or a modem) that enables the processing device to communicate with one or more other computing devices. Such communication may be performed by using an input/output (I/O) interface 850. In addition, the processing device 100 may further communicate with one or more networks (for example, a local region network (LAN), a wide region network (WAN), and/or a public network, such as Internet) by using a network interface controller 860. It is to be understood that although not shown in the figure, other hardware and/or software modules may be used in combination with the processing device 100, including, but not limited to microcode, a device drive, a redundancy processing unit, an external disk drive array, a RAID system, a tape drive, a data backup storage system, or the like.

According to the foregoing descriptions of the implementations, those of ordinary skill in the art may readily understand that the example implementations described herein may be implemented by using software, or may be implemented by combining software and necessary hardware. Therefore, the technical solutions of the embodiments of the disclosure may be implemented in a form of a software product. The software product may be stored in a non-volatile storage medium (which may be a compact disc read-only memory (CD-ROM), a USB flash drive, a removable hard disk, or the like) or in a network and includes several instructions for instructing a computing device (which may be a personal computer, a server, a terminal device, a network device, or the like) to perform the methods described in the embodiments of the disclosure.

In an example embodiment of the disclosure, a non-transitory computer program medium is further provided, storing computer-readable instructions, the computer-readable instructions, when executed by a processor of a computer, causing the computer to perform the method described in the foregoing method embodiments.

According to an embodiment of the disclosure, a program product for performing the method in the foregoing method embodiments is further provided. The program product may use a portable CD-ROM and include program code, and may be run on a terminal device such as a personal computer. However, the program product of the disclosure is not limited to this. In this specification, the readable storage medium may be any tangible medium including or storing a program, and the program may be used by or in combination with an instruction execution system, apparatus, or device.

The program product may be any combination of one or more readable mediums. The readable medium may be a computer-readable signal medium or a computer-readable storage medium. The readable storage medium may be, for example, but is not limited to, an electric, magnetic, optical, electromagnetic, infrared, or semi-conductive system, device, or device, or any combination thereof. More examples (a non-exhaustive list) of the readable storage medium may include: an electrical connection having one or more wires, a portable disk, a hard disk, a RAM, a ROM, an erasable programmable ROM (EPROM or flash memory), an optical fiber, a portable CD-ROM, an optical storage device, a magnetic storage device, or any appropriate combination thereof.

The computer-readable signal medium may include a data signal propagated in a baseband or as part of a carrier, and stores readable program code. The propagated data signal may be in multiple forms, including but not limited to, an electromagnetic signal, an optical signal, or any appropriate combination thereof. The readable signal medium may alternatively be any readable medium other than the readable storage medium. The readable medium may be configured to send, propagate, or transmit a program used by or used in combination with an instruction execution system, an apparatus, or a device.

The program code included in the readable medium may be transmitted by using any appropriate medium, including but not limited to, a wireless medium, a wired medium, an optical cable, radio frequency (RF) or the like, or any appropriate combination thereof.

The program code used for executing the operations of the disclosure may be written by using one or more programming languages or a combination thereof. The programming languages include an object-oriented programming language such as Java, C++ and the like, and also include a conventional procedural programming language such as “C” or similar programming languages. The program code may be completely executed on a user computing device, partially executed on a user device, executed as an independent software package, partially executed on a user computing device and partially executed on a remote computing device, or completely executed on a remote computing device or server. In a case involving a remote computing device, the remote computing device may be connected to a user computing device through any type of network including a LAN or a WAN, or may be connected to an external computing device (for example, through the Internet by using an Internet service provider).

It is to be noted that, although several modules or units of a device for action execution are mentioned in the foregoing detailed descriptions, the division is not mandatory. Actually, according to the embodiments of the disclosure, the features and functions of two or more modules or units described above may be specified in one module or unit. Conversely, features and functions of one module or unit described above may be further divided into a plurality of modules or units to be specified.

In addition, although the various steps of the method in the disclosure are described in a specific order in the accompanying drawings, this does not require or imply that the steps are bound to be performed in the specific order, or all the steps shown are bound to be performed to achieve the expected result. Additionally, or alternatively, some steps may be omitted, a plurality of steps may be combined into one step for execution, and/or one step may be decomposed into a plurality of steps for execution, and the like.

According to the foregoing descriptions of the embodiments, those of ordinary skill in the art may readily understand that the example implementations described herein may be implemented by using software, or may be implemented by combining software and necessary hardware. Therefore, the technical solutions of the embodiments of the disclosure may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a mobile terminal, a network device, or the like) to perform the methods according to the embodiments of the disclosure.

After considering the specification and practicing the embodiments disclosed herein, those of ordinary skill in the art may easily conceive of other embodiments of the disclosure. The disclosure is intended to cover any variations, uses, or adaptive changes of the disclosure. These variations, uses, or adaptive changes follow the general principles of the disclosure and include common general knowledge or common technical means in the art, which are not disclosed in the disclosure. The specification and the embodiments are merely considered as examples, and the actual scope and the spirit of the disclosure are pointed out by the following claims.

What is claimed is:

1. A processing control method, comprising:
emitting a light beam to a processing object to form a light beam coverage region on the processing object through lights in the light beam, wherein the light beam coverage region comprises a plurality of measurement points;
obtaining positional information of pixel points mapped by the measurement points from an image corresponding to the light beam coverage region; and
obtaining coordinate information of each measurement point in the light beam coverage region according to a pre-configured calibration relationship and the positional information of the pixel points, wherein the coordinate information is used for the processing on the processing object.

2. The method of claim 1, wherein emitting the light beam to the processing object to form the light beam coverage region on the processing object through the lights in the light beam comprises:
emitting the light beam to form the light beam coverage region through the lights in the light beam; and
controlling movement of the light beam according to a relative position of the light beam coverage region to the processing object to form the light beam coverage region on the processing object.

3. The method of claim 2, wherein emitting the light beam to the processing object to form the light beam coverage region on the processing object through the lights in the light beam further comprises:
in response to determining that the light beam coverage region fails to fully cover the processing object, continuing to move the light beam coverage region after obtaining positional information of a pixel point mapped by a current measurement point, to make the light beam coverage region continue to cover other regions of the processing object until the processing object is fully measured.

4. The method of claim 1, wherein obtaining positional information of the pixel points mapped by the measurement points from the image corresponding to the light beam coverage region comprises:
obtaining the image corresponding to the light beam coverage region;
identifying a pixel point in the image corresponding to each measurement point; and
calculating, according to positions of the pixel points in the image, to obtain the positional information of the pixel point in the image mapped by each measurement point.

5. The method of claim 1, further comprising:
performing linear fitting on coordinate information of measurement points on processing objects with different heights and the positional information of pixel points corresponding to the measurement points, to obtain the calibration relationship between coordinate information of the measurement points and the positional information of corresponding pixel points.

6. The method of claim 5, wherein obtaining the coordinate information of each measurement point in the light beam coverage region according to the pre-configured calibration relationship and the positional information of the pixel points, comprises:
substituting the positional information of the pixel points into the calibration relationship between coordinate information of the measurement points and the positional information of the pixel points to obtain reference coordinate information of the measurement points with a camera as a reference point; and
calculating, according to coordinate information of the camera in a machine coordinate system with an original point as a reference point constructed by a processing device and the reference coordinate information of the measurement points, coordinate information of the measurement points in the machine coordinate system with the original point as the reference point.

7. The method of claim 6, wherein substituting the positional information of the pixel points into the calibration relationship between the coordinate information of the measurement points and the positional information of the pixel points to obtain the reference coordinate information of the measurement points with the camera as the reference point, comprises:
reading coefficients from a calibration file corresponding to the measurement points, and constructing, using the read coefficients, functions between the positional information of the pixel points and a reference coordinate value, and functions between reference coordinate values; and
identifying the image to obtain the positional information of the pixel points, and calculating the reference coordinate information of the measurement points corresponding to the pixel points according to the functions.

8. The method of claim 5, wherein after obtaining the coordinate information of each measurement point in the light beam coverage region according to the pre-configured calibration relationship and the positional information of the pixel points, the method further comprises:
generating a processing region model according to the coordinate information of each measurement point on the processing object;
matching a pattern mapped by a target processing graphic to the processing region model for processing alignment, and obtaining pattern transformation data of the target processing graphic on the processing region model; and
processing the pattern mapped by the target processing graphic on the processing object according to the pattern transformation data.

9. The method of claim 1, wherein a processing device configured to perform the processing comprises a light source configured to emit the light beam and form the plurality of measurement points in the light beam coverage region.

10. The method of claim 9, wherein grids and/or a galvanometer mirror is arranged in an optical path of the light source, and the lights are distributed to form the plurality of measurement points in the light beam coverage region through the grids and/or the galvanometer mirror.

11. The method of claim 1, wherein the lights form grid lines or a dot matrix in the light beam coverage region, and the plurality of measurement points in the light beam coverage region correspond to the intersections of the grid lines or dots in the dot matrix.

12. A processing device, comprising:
a housing;
a rail apparatus;
a laser head, wherein the laser head slides through the rail apparatus; and
a communication component, wherein the communication component is configured to receive signal;
wherein the processing device is configured to execute:
emitting a light beam to a processing object to form a light beam coverage region on the processing object through lights in the light beam, wherein the light beam coverage region comprises a plurality of measurement points;
obtaining positional information of pixel points mapped by the measurement points from an image corresponding to the light beam coverage region; and
obtaining coordinate information of each measurement point in the light beam coverage region according to a pre-configured calibration relationship and the positional information of the pixel points, wherein the coordinate information is used for the processing on the processing object.

13. The processing device of claim 12, wherein the processing device further comprises a camera, wherein the camera is disposed on the laser head, and the camera is configured to capture the light beam coverage region on the processing object to obtain a corresponding image.

14. The processing device of claim 12, wherein the processing device further comprises a light source, wherein the light source is used to emit the light beam and form the plurality of measurement points in the light beam coverage region.

15. The processing device of claim 12, wherein in terms of obtaining the positional information of the pixel points mapped by the measurement points from the image corresponding to the light beam coverage region, the processing device is configured to execute:
obtaining the image corresponding to the light beam coverage region;
identifying a pixel point in the image corresponding to each measurement point; and
calculating, according to positions of the pixel points in the image, to obtain the positional information of the pixel point in the image mapped by each measurement point.

16. A processing system, comprising:
a processing device, wherein the processing device comprises a housing, a rail apparatus, a laser head, and a communication component; and
a processing control device, wherein the processing control device communicates with the processing device, and the processing control device is configured to control the processing device to execute:
emitting a light beam to a processing object to form a light beam coverage region on the processing object through lights in the light beam, wherein the light beam coverage region comprises a plurality of measurement points;
obtaining positional information of pixel points mapped by the measurement points from an image corresponding to the light beam coverage region; and
obtaining coordinate information of each measurement point in the light beam coverage region according to a pre-configured calibration relationship and the positional information of the pixel points, wherein the coordinate information is used for the processing on the processing object.

17. The processing system of claim 16, wherein in terms of emitting the light beam to the processing object to form the light beam coverage region on the processing object through the lights in the light beam, the processing control device is configured to control the processing device to execute:
emitting the light beam to form the light beam coverage region through the lights in the light beam; and
controlling movement of the light beam according to a relative position of the light beam coverage region to the processing object to form the light beam coverage region on the processing object.

18. The processing system of claim 17, wherein in terms of emitting the light beam to the processing object to form the light beam coverage region on the processing object through the lights in the light beam, the processing control device is configured to control the processing device to further execute:
in response to determining that the light beam coverage region does not fully cover the processing object, continuing to move the light beam coverage region after obtaining positional information of a pixel point mapped by a current measurement point, to make the light beam coverage region continue to cover other regions of the processing object until the processing object is fully measured.

19. The processing system of claim 16, wherein in terms of obtaining positional information of the pixel points mapped by the measurement points from the image corresponding to the light beam coverage region, the processing control device is configured to control the processing device to further execute:
obtaining the image corresponding to the light beam coverage region;
identifying a pixel point in the image corresponding to each measurement point; and
calculating, according to positions of the pixel points in the image, to obtain the positional information of the pixel point in the image mapped by each measurement point.

20. A non-transitory computer program medium, storing a computer-readable instruction, wherein the computer-readable instruction, when executed by a processor of a computer, causes the computer to execute the method of claim 1.
